(19) United States
(12) Patent Application Publication
(10) Pub. No.: US 2017/0213239 A1
(43) Pub. Date: Jul. 27, 2017

(54) AUDIENCE REACH OF DIFFERENT ONLINE ADVERTISING PUBLISHERS

(71) Applicant: Facebook, Inc., Menlo Park, CA (US)

(72) Inventors: Frederick Ross Leach, San Francisco, CA (US); Bradley Hopkins Smallwood, Palo Alto, CA (US)

(21) Appl. No.: 15/007,128

(22) Filed: Jan. 26, 2016

(51) Int. Cl. G06Q 30/02; G06Q 50/00

(52) U.S. Cl. CPC G06Q 30/0245; G06Q 50/01

(57) ABSTRACT

An advertisement impression management system receives an audience list that identifies a set of users associated with an interest topic. The system also identifies whether users associated with advertisements displayed by advertising publishers are in the received audience list. Advertising impression data associated with the displayed advertisements is received by the system to identify users accessing the displayed advertisements. The system identifies unique users based on online tracking methods and user information extracted from user databases of a social networking system. Correction techniques and external panel data are used to correct user information of the identified unique users to improve accuracy. An audience report is generated by the system to evaluate the ability and effectiveness of the advertising publishers in reaching members of the users in the audience list.

### BACKGROUND

This disclosure relates generally to online advertising, and more specifically, to estimating the effectiveness of online advertising by different online publishers.

In an online advertising environment, advertisers contract with advertising publishers to provide advertisements to users. Advertising publishers are online platforms that provide advertisements received from advertisers for an online audience to view. These publishers disseminate digital advertisements via the Internet and are often interested in estimating the viewership of the content of the digital advertisements. For example, advertisers are interested in estimating the number of impressions and the number of unique users that viewed a particular advertisement in various different demographic groups with different characteristics, such as age, gender and interests.

The ability of different online publishers to reach audiences including different groups of people may vary according to the variability of user databases for each publisher and how each publisher targets an online audience. Audience reports may be generated to reflect each online publisher's ability to reach the audience for an advertisement. However, in existing online advertising systems, these audience reports may be self-determined by the online publishers, and comparison between publishers is difficult. In addition, it is difficult to determine whether a publisher is successfully targeting groups that do not have predefined audience demographics.

### SUMMARY

An advertising (ad) impression management system evaluates the effectiveness of advertising reach by different advertising publishers and provides audience reports describing the audience that views or interacts with advertisements displayed by each advertising publisher. The audience reports may describe demographic information about the audience and about the advertising campaign as a whole. The demographic information may describe characteristics of the audience, as well as audience membership in an audience list.

The ad impression management system receives an audience list for reference from a list provider. The audience list describes a group of users who are targeted by advertisers. For example, an audience list can be a list of auto-intenders (e.g., those in the market for a car) who may be targeted by a car manufacturer for advertisements. The ad impression management system uses the audience list to determine the efficacy of each advertising publisher at providing advertisements to members in the audience list.

When an advertising publisher provides an advertisement, a user device receives the advertisement, and this advertisement can include a tracking pixel. The tracking pixel causes the user device to then contact and provide ad impression data related to that ad to the ad impression management system. The ad impression data received by the ad impression management system includes a campaign ID identifying an advertising campaign, a publisher ID identifying the publisher that provided the advertisement to the user device and a user ID identifying a user accessing the user device. The ad impression management system stores ad impression data and then identifies whether the user is in the audience list to evaluate the effectiveness of the online publishers in reaching the desired audience. For example, the ad impression management system compares and matches user identifiers of the users in the audience list and user ID extracted from the ad impression data.

In one embodiment, the ad impression management system interacts with or is a social networking system that has a large user database. After receiving the user information from the user device, the ad impression management system identifies whether the user is database registered user of the social networking system. After determining that the user belongs to database registered user of the social networking system, the ad impression management system then logs attributes for the user based on the user's own information (e.g., age, gender, interests) provided by user databases of the social networking system. The ad impression management system further determines whether the user belongs to any audience lists. For example, the ad impression management system compares user identifiers of the users in the audience list and user identifiers extracted from the user database from the social networking system.

The user information stored in the social networking system may have errors with respect to actual information about users. For example, a user may be listed as 47 years old in the social networking system but actually be 33 years old. To solve this problem, in one embodiment, the social networking system uses behavior analysis or machine-based recognition technology to correct user data. In another embodiment, panel data and correction technologies from other data providers or within the ad impression management system itself are used to correct user data in the social networking system to enhance the accuracy of the user data.

An audience report can be generated by the ad impression management system to show the effectiveness of each online publisher in reaching the audience. In some embodiments, the audience report includes overall evaluation of the advertising reach ability of all online publishers. The audience report also includes for each online publisher the total number of ad impressions the system receives, the total number of unique users, the number of users reached in the audience list, the number of users not reached in the audience list, and other details about the audience.

In one embodiment, the online publisher is provided with the audience list and tries to reach the users in the list. In another embodiment, the online publisher is not provided with the audience list and may nonetheless provide advertisements to users that are on the audience list. The ad impression management system can determine the advertising reach of both kinds of online publishers in reaching members of the audience list.

### BRIEF DESCRIPTION OF THE DRAWINGS

FIG. 1 (FIG. 1) is a high-level block diagram of a system environment for an advertisement impression management system that measures audience reach of advertisements provided by ad publishers, according to one embodiment.

FIG. 2 is a block diagram of the architecture of the advertisement impression management system, according to one embodiment.

FIG. 3 shows a conceptual dataflow for determining an audience report, according to one embodiment.

FIG. 4 shows an example audience report generated by the advertisement impression management system, according to one embodiment.

FIG. 5 shows an example of publisher reach and list targeting, according to one embodiment.

FIG. 6 shows an example table of ad impression data collected by the advertisement impression management system, according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED FIGURE DESCRIPTION

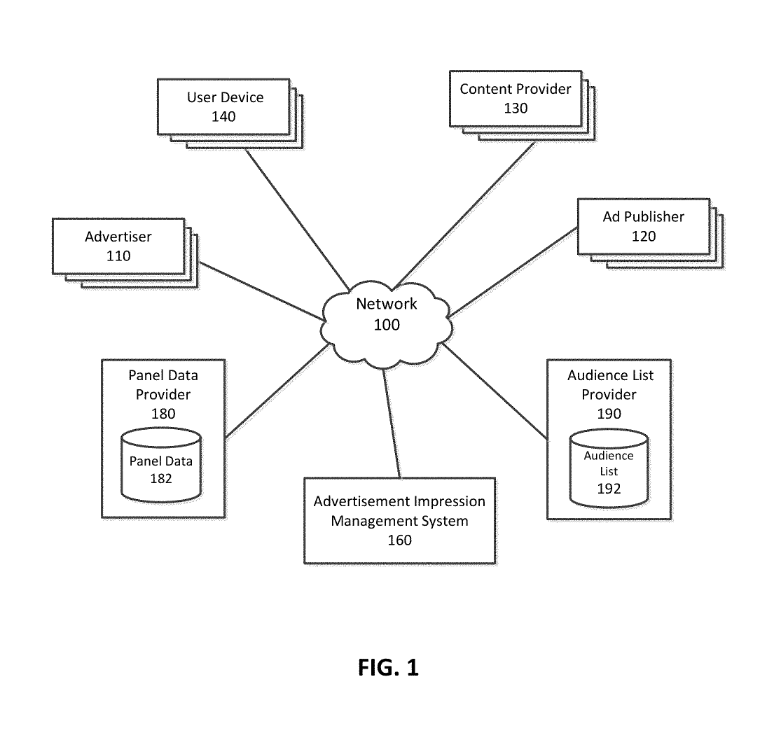

FIG. 1 is a high-level block diagram of a system environment for an advertisement impression management system that measures audience reach of advertisements provided by ad publishers, according to one embodiment. In the embodiment of FIG. 1, the system environment includes one or more advertisers 110, one or more advertising publishers 120, one or more content providers 130, one or more user devices 140, an audience list provider 190, an advertisement impression management system 160, a panel data provider 180 and a network 100. In alternative configurations, additional or fewer components may be included in the system environment.

As more fully described below, the advertisement impression management system 160 receives an audience list from the audience list provider 190, and determines ad impression data of users that received advertisements from the advertising publisher 120. The ad impression data can describe whether the users targeted by the advertising publisher 120 are members of the audience list, among other demographic information. This permits measurement of the degree to which advertisers successfully reach the users provided on the audience list.

An audience list provider 190 provides audience lists that identify groups of users associated with specific interest topics. An audience list may identify the users as being interested in the topic (i.e., these users like cars) or as interested in purchasing specific products or services (i.e., these users want to buy cars). The audience list uniquely identifies users in a way that may also identify those users in another system. For example, the audience list may specify names, email addresses, IP addresses or other identifiers of users (e.g., user account information for specific social networking systems or for other online applications). In another example, the audience list associates users with individual tracking identifiers, such as a tracking pixel for a web browser. The audience list provider 190 can be a data provider with access to different data sources. An audience list provider 190 can also be an advertiser who is interested in targeting groups of users associated with specific products or services, or may be a separate data aggregator that determines the audience list 192. In one embodiment, the audience list provider 190 receives audience data, for example, name, email address and interests on products or services by using different kinds of tracking methods, for example, cookies and tracking tags and pixels. In another embodiment, an audience list provider 190 receives a user's purchasing intentions from third-party online shopping websites which has a shopping history record of that user. The audience list 192 provided by the audience list provider 190 can be, for example, an auto-intender list that targets people in the car-purchasing market, or a dog-food buyer list which targets people who want to buy dog food. The audience list 192 is provided to an advertisement impression management system 160 as described below. In some embodiments, one or more of the advertising publishers 120 are also provided with the audience list 192. When an advertising publisher 120 receives the audience list 192, the advertising publisher 120 may attempt to target users on the audience list 192 and provide with the users with advertisements they may be interested in. Thus, in some circumstances the advertisement impression management system 160 measures the ability of an advertising publisher 120 to reach members of the audience list 192 when the advertising publisher has the audience list, and in other circumstances measures the ability of the advertising publisher to reach the members of the audience list when the advertising publisher does not have the audience list. In some embodiments, multiple audience lists that identify different groups of users with different targeting purposes can be provided to the advertisement impression management system 160 or to advertising publishers 120.

In the system environment shown in FIG. 1, one or more advertisers 110 submit advertisements to advertisement publishers 120 for delivery to various users accessing the content providers 130. The content providers 130 provide content requested by the user devices 140. The content providers 130 may include, for example various types of systems that provide content such as text, image, video, and other types of information of interest to users. The content providers 130 may also direct user devices 140 to advertisement publishers 120 to select and provide advertisements for display with the content provided by the content providers. In alternate embodiments, a content provider 130 retrieves the advertisement from an ad publisher 120 and provides the advertisement to a user accessing a user device 140.

The advertising publisher 120 is an advertising platform that selects advertisements from advertisers 110 and provides the selected advertisements to content providers 130 for presentation to users on the user devices 140. The advertisers 110 may also specify an advertising campaign associated with the advertisements they submit. Example advertising publishers 120 include search engines, social networking systems, news distribution systems, online forums and any other electronic systems or webpage hosting platforms that provide advertisements for content providers 130. While a user accesses the content provider 130 to receive content, the selection and placement of advertisements to accompany the content is performed by an advertising publisher 120. As one example, the advertising publisher 120 is a search engine and the content provider 130 is a news webpage. The search engine publisher 120 fills the advertising slots on the news webpage with advertisements for online users to view. In some configurations, the content provider 130 is also the advertising publisher 120 and the content provider also selects and provides its own advertisements.

The user device 140 is a computing device that is capable of receiving user input as well as communicating via the network 100. One or more user devices 140 can communicate within the system environment illustrated by FIG. 1. In one embodiment, a user device 140 can be a conventional computer system, such as a desktop or a laptop computer. In another embodiment, the user device 140 can be a mobile telephone, a smartphone or a personal digital assistant (PDA). The user device 140 is configured to communicate within the network 100 and interact with the content provider 130 to receive advertisements provided by the advertising publishers 120 and provide information about the advertisements and the user accessing the advertisements to the advertisement impression management system 160 as described below. Users can view the advertisements displayed on the content providers 130 via the user devices 140. In one embodiment, the user device 140 interacts with other components in the network 100 through an application programming interface (API) running on a native operating system of the user device 140, such as IOS® or ANDROID™.

The network 100 illustrated in FIG. 1 uses standard communications technologies and/or protocols such as Ethernet, 802.11, worldwide interoperability for microwave access (WiMAX), 3G, 4G, code division multiple access (CDMA), etc. Example communication protocols include transmission control protocol/Internet protocol (TCP/IP), hypertext transport protocol (HTTP), file transfer protocol (FTP) and multiprotocol label switching (MPLS). Data exchanged over the network 100 can be represented for example, in the format of hypertext markup language (HTML) or extensible markup language (XML). Additional technologies may also be used in the network 100.

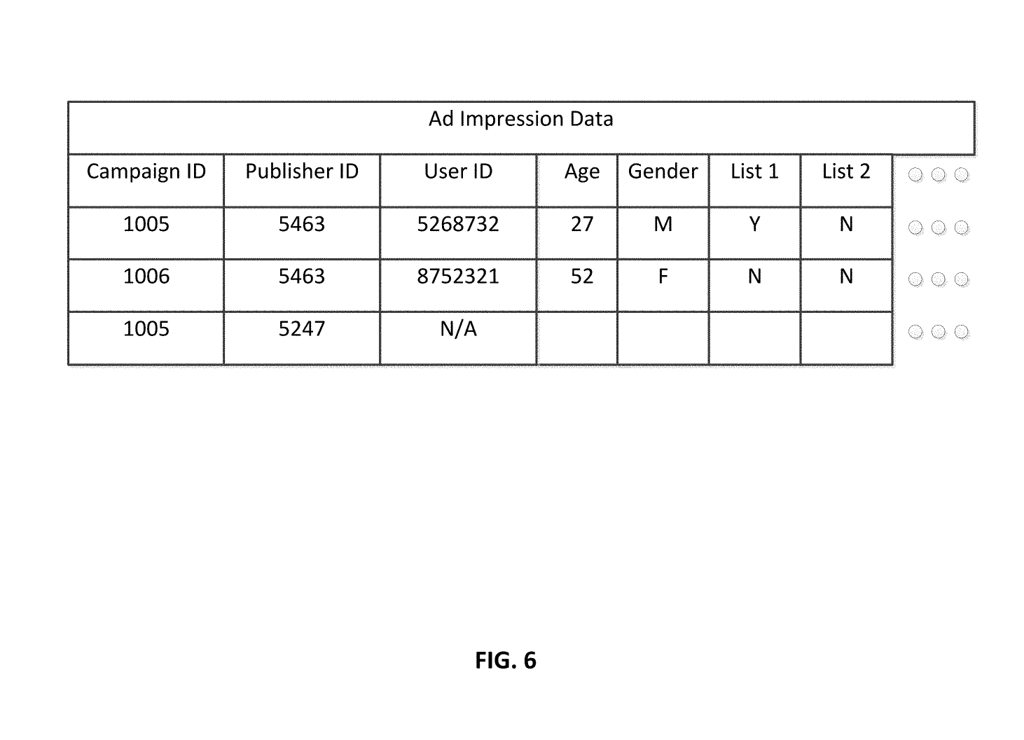

FIG. 1 further illustrates an advertisement impression management system 160 that obtains advertisement impression data received from the user devices 140. When advertisements are provided to a user device 140, the advertisement impression management system 160 identifies information about the user viewing the advertisement. In one embodiment, the advertising(ad) impression data, as shown in FIG. 6, identifies a specific advertisement viewed by the user, a campaign ID identifying an advertisement campaign that is related to this advertisement, a publisher ID identifying the advertising publisher 120 that provided the advertisement to the user device 140, and a user ID identifying the user accessing the user device 140. In another embodiment, the advertising impression data may include age and gender information of the user. Additional information may be included in the advertising impression data such as the email address, the phone number and other personal information of the user viewing or interacting with the advertisement that is tracked and recorded in the advertising impression data.

In some embodiments, the advertisement impression management system 160 identifies user information for a user on a user device 140 from a social networking system 320 as described below. Based on the user information received both from ad impression data and from social networking system 320, the advertisement impression management system 160 determines whether a user accessing the advertisement is on the audience list 192 that is provided to the advertisement impression management system 160. The advertisement impression management system 160 generates an audience report describing the effectiveness of different advertising publishers 120 in reaching the correct audience of users.

FIG. 6 illustrates an example table of ad impression data collected by the advertisement impression management system 160. As shown in this example, the ad impression data for each advertisement may identify a campaign id, a publisher id, and when available, identifies a user along with characteristics of the user, such as the user's age, gender, and other details according to the various embodiments. The ad impression data, after analysis by the advertisement impression management system 160, may also indicate whether each identified user belongs to various audience lists. In the example of FIG. 6, campaign ID 1005 is associated with two advertising impressions, each from a different publisher (having different publisher IDs). In this example, the first advertising impression, associated with publisher ID 5463, was identified as belonging to User ID 5268732, having certain characteristics and identified as being in audience list 1 but not in audience list 2. For the impression of campaign ID 1005 at publisher 5247, no user was identified for the impression, though the impression was provided to a client. In some examples, even though no user ID was identified, a unique identifier based on a token, cookie, device identifier, or other identification of the client device may still be used to identify the device or session of the user receiving the advertisement.

Returning to FIG. 1, the advertisement impression management system 160 interacts with other components such as content providers 130, the audience list provider 190, the user device 140 and the panel data provider 180 as described below within the network 100.

In some embodiments, the user information extracted from the advertising impression data or from the social networking system 320 reflects user-provided information and may not accurately reflect actual user characteristics. The panel data provider 180 provides panel data 182 to correct the user information received by the advertisement impression management system 160 to improve accuracy of the audience report. A panel data provider 180 maintains a set of data about known families, households, and other confirmed information about users, termed panel data. The panel data describes these confirmed user demographics and user characteristics.

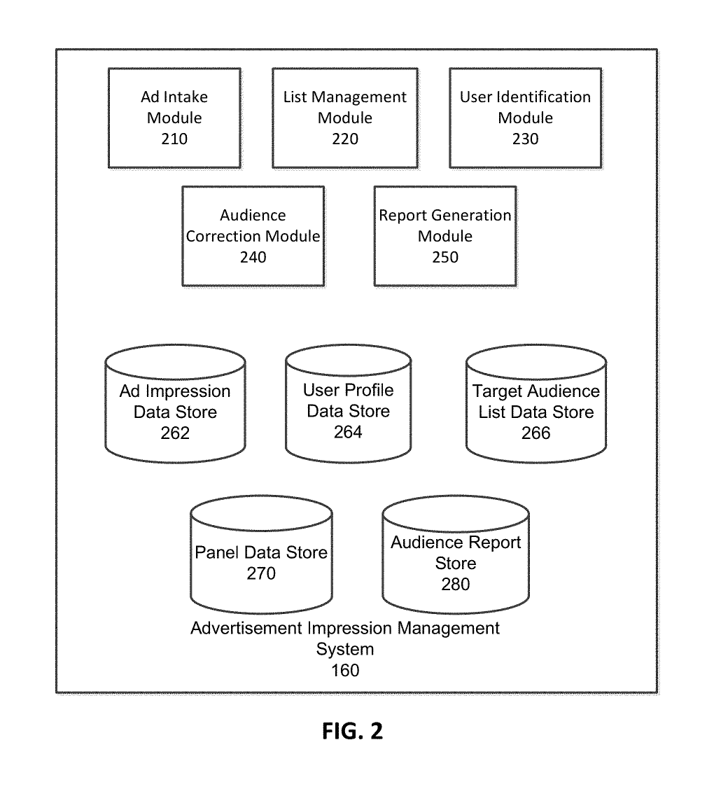

FIG. 2 is an example block diagram of the architecture of the advertisement impression management system 160, according to one embodiment. In the embodiment of FIG. 2, the advertisement impression management system 160 includes an advertising (ad) intake module 210, a list management module 220, a user identification module 230, an audience correction module 240 and a report generation module 250. The advertisement impression management system 160 further includes an ad impression data store 262, a user profile data store 264, a target audience list data store 266, a panel data store 270 and an audience report store 280. Some embodiments of the advertisement impression management system 160 include different components than those described in conjunction with FIG. 2. The functions described below of the components may be distributed among components in the advertisement impression managements system 160 in a different matter than is described here.

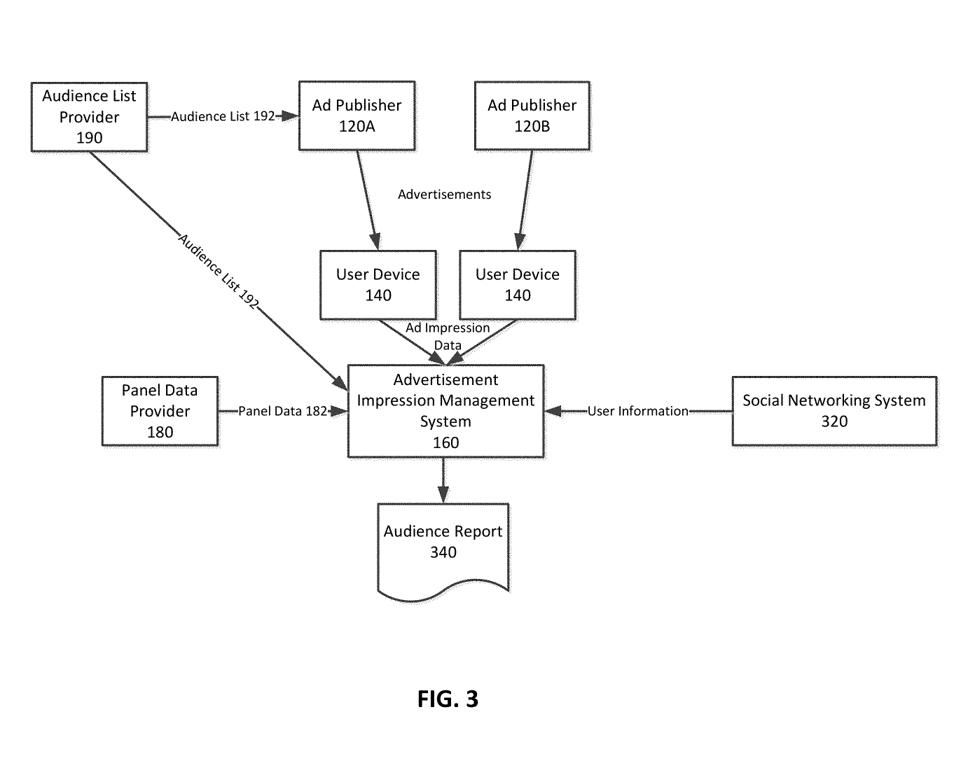

FIG. 3 shows a conceptual dataflow for determining an audience report, according to one embodiment. An audience list 192 with a specific interest topic or a targeting purpose is provided by an audience list provider 190 to the advertisement impression management system 160.

Returning to FIG. 2, the list management module 220 receives the audience list 192 and stores in the target audience list data store 266 the audience list data extracted from the audience list 192. The target audience list data store 266 may include information about individual audience lists, and identify specific users related to a specific interest topic or a purchasing intention for a specific object or service. Example audience list data includes name, email address, IP address, user account of social networking systems or other online applications or other personal information that identifies the user associated with the specific interest topic.

As shown in FIG. 3, in one embodiment, the advertising publisher 120A has access to the audience list 192 provided to the advertisement impression management system 160 and the advertising publisher 120A may intend to reach the members in the audience list 192 and selects and provides advertisement to users of the list for an advertiser targeting the list. In another embodiment, the advertising publisher 120B has no access to the audience list 192 and provides advertisements for various users accessing the advertising publisher 120B, some of whom are members in the audience list 192. The advertising publisher 120B may also provide advertisements to the users that are not in the audience list 192.

A user receives in the user device 140 the advertisement provided by the advertising publisher 120 through a content provider 130 as described above. In one embodiment, the content provider 130 displays the advertisement on a user device 140 for users to view. The user accessing the user device may view or interact with the advertisement. For example, a user may view an advertisement in an advertising slot on a website represented by the content provider 130 on the user device 140. The user may interact with the advertisement in various ways, for example, by clicking on the advertisement. When the user interacts with the advertisement, the user may be directed to another landing page of the advertisement to view more detailed information about the product or service described in the advertisement. When the user device 140 accesses the advertisement and the user interacts with the advertisement, the user device may follow a tracking pixel or otherwise provides advertising impression data to the advertisement impression management system 160. The ad impression data includes information about the advertising publisher 120 and the user device 140.

The user device 140 then provides ad impression data to the advertisement impression management system 160. Returning to FIG. 2, the ad intake module 210 receives and processes the ad impression data which is stored in the ad impression data store 262. In some embodiments, the ad impression data store 362 may include information for that specific advertisement about a campaign ID identifying an advertisement campaign that is associated with an interest topic and is related to this advertisement and its advertiser, a publisher ID identifying the advertising publisher 120 that provides the advertisement to the user device 140 and a user ID identifying the user accessing the user device 140. Other information can also be included in the ad impression data.

The advertisement impression management system 160 may interrogate the user device 140 to determine the user ID and other characteristics of the user, for example by retrieving stored cookies or other tracking data of the user device 140. In some embodiments, the advertisement impression management system 160 accesses a social networking system 320 to determine characteristics associated with the user ID. In one embodiment, after the ad impression data from the user device 140 is received by the advertisement impression management system 160, the user identification module 230 checks with the user database in the social networking system 320 to identify whether the user with an associated user ID who accesses the user device 140 belongs to the users registered in the social networking system 320. If the user does not belong to the users registered in the social networking system 320 and/or has no history data stored in the social networking system 320, the advertisement impression management system 160 may store the ad impression information without specific user information. If the user belongs to the users registered in the social networking system 320, the advertisement impression management system 320 stores in the user profile data store 264 the user information received from the user device 140. The user profile information stored in the user database in the social networking system 320 for that specific user is also extracted and then stored in the user profile data store 264 inside the advertisement impression management system 160. The user profile information extracted from the social networking system 320 for a specific user may include basic information such as name, age, gender, demographic information, education history and work history. The user profile information may also include information such as personal interest on a specific product or on a specific brand generated by behavior analysis or machine learning technologies in the social networking system 320.

In one embodiment, the ad impression management system 160 matches the user profile information, for example, IP address or email address, with user information in the audience list 192 to decide whether a user is in the list 192. Other matching methods can also be used to determine whether a user is on the audience list 192.

In some embodiments, the user information provided by the ad impression data or by the social networking system 320 is not accurate or does not correctly reflect real information about the user. For example, a user logs onto the social networking system 320 with someone else's account and is directed to the advertisement impression management system 160 after interacting with an advertisement provided by an advertising publisher 120. The user account with which the user logs on and the associated user profile information in the social networking system 320 does not represent the user who actually accesses this advertisement. In another example, the user who logs onto the social networking system 320 with his/her own account but provides fake age or gender information in the social networking system 320. The audience correction module 240 corrects the user information extracted from the ad impression data and from the social networking system 320. Returning to FIG. 2, in one embodiment, the social networking system 320 applies some correction techniques to identify and correct user information for its registered users. In another embodiment, panel data 182 provided by a panel data provider 180 is received and stored in the panel data store 270 to correct user profile data. The panel data 180 may be used to train a model that predicts, for a set of profile data, the characteristics of user profiles for an audience as a whole, even where only some of the users are identified. After the user profile data is corrected, the report generation module 250 determines whether the user directed to the advertisement impression management system 160 is in the audience list 192. The report generation module 250 also generates an audience report 340 that will be stored in the audience report store 280. The audience report may be provided to advertising publishers 120 or to advertisers 110.

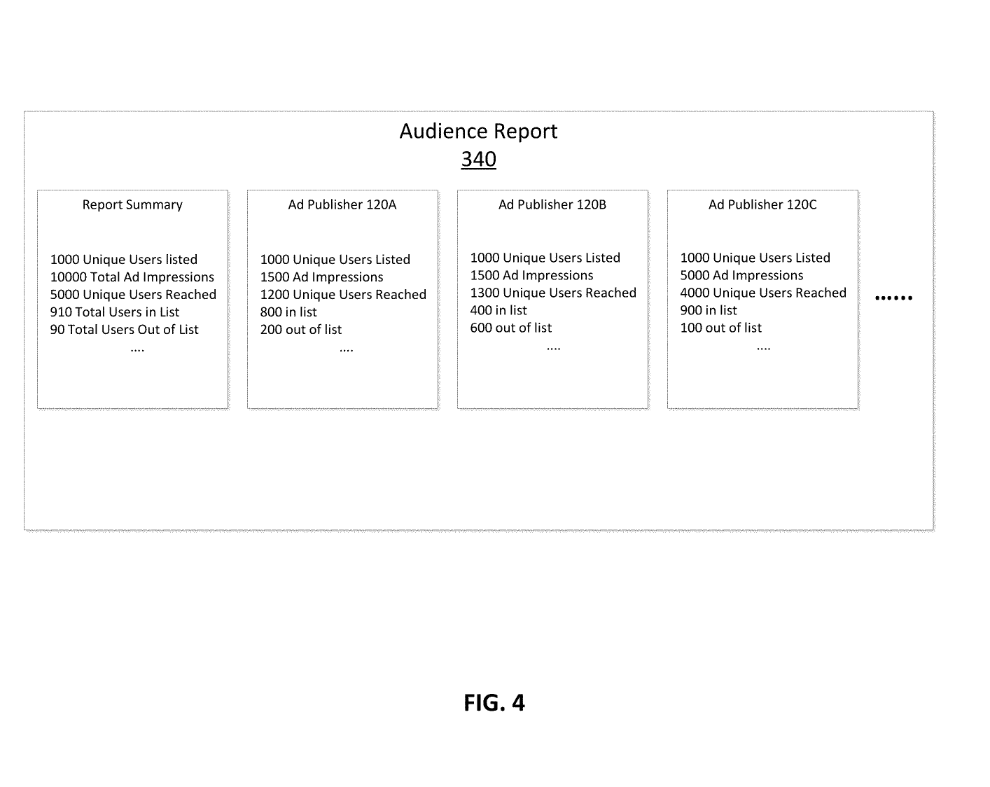

FIG. 4 shows an example audience report generated by the advertisement impression management system 160. In the embodiment of FIG. 4, the audience report 340 includes a report summary and individual reports for each advertising publisher 120A-120C and may also include publishers not shown in FIG. 4. The report summary includes overall information such as the number of unique users reached by the advertising campaign as a whole across many ad publishers, such as the number of unique users reached in the audience list 192, the number of total ad impressions received by the system 160, the number of all the unique users reached by the system 160, the number of total users in list and the number of total users out of list. Different and additional information may also be included in the report summary. In some embodiments, a same user or a user with the same user ID views or interacts with several advertisements with different campaign IDs and with different publisher IDs. In one embodiment, a single unique user represents all the impressions for a single user ID. A user in the audience list represents a user that is reached by the advertisement impression management system 160 and is also in the audience list 192. A user out of list represents a user reached by the advertisement impression management system 160 but who was not identified as in the audience list 192. Additional information can also be included in the report such as the users that are reached by an advertising publisher 120 but are not in the list.

In the report summary shown in FIG. 4, the audience list has 1000 unique users that different ad publishers may or may not intend to target. The ad impression management system 160 receives 10000 ad impressions in total and reaches 5000 unique users. Among the 5000 unique users reached by the system 160, 910 users are in the audience list 192. The rest 90 users in the audience list 192 are not targeted by any ad publisher. In addition to the data shown in FIG. 4, the audience report may also provide a summary of user characteristics, such as those resulting from the application of panel data to the identified users, for example to identify age or gender of users.

The report for each advertising publisher 120A-120C further includes information about user reach for each ad publisher 120A-120C. Different and additional information may also be included in the report for each advertising publisher 120A-120C. In the report for ad publisher 120A, 1500 ad impressions received by the system 160 are from ad publisher 120A and 1200 unique users are reached by ad publisher 120A. 800 users in the audience list 192 are reached by ad publisher 120A and the rest 200 users in the list 192 are not reached by ad publisher 120A. In the report for ad publisher 120B, 1500 ad impressions received by the system 160 are from ad publisher 120B and 1300 unique users are reached by ad publisher 120B. 400 users in the audience list 192 are reached by ad publisher 120B and the rest 600 users in the list 192 are not reached by ad publisher 120B.

The audience report 340 can reflect the effectiveness of different publishers to reach the audience in the list. In one embodiment, in the audience report 340, a larger number of the “users in list” indicates a stronger ability to reach the audience in the list 192. A variety of factors cause the audience reach of different advertising publishers 120A-120C to vary. In one embodiment, some advertising publishers, for example, advertising publisher 120A is provided with the audience list and intentionally selects the advertisement that may attract the members in the audience list 192, which shows from the audience report 340 a higher percentage and better performance in reaching the audience in the list 192 for publisher 120A. In another embodiment, the advertising publishers 120B which may not be provided with the audience list 192 shows performance not as good as publisher 120A. The size and accuracy of the user databases and the tracking ability of different advertising publishers may vary, which also causes the audience-reach results shown in the audience report 340 to vary. By collecting these user statistics, and generating the audience reports for each publisher, an advertiser can determine the effectiveness of each advertiser's advertising presentation efforts.

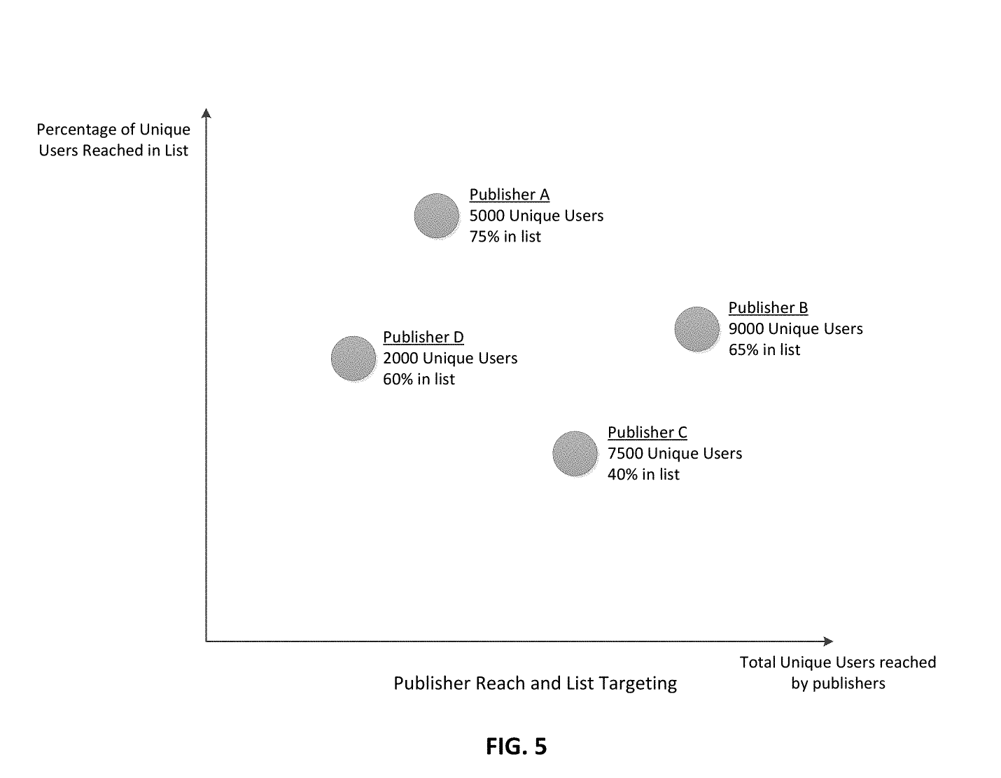

FIG. 5 shows an example of publisher reach and list targeting, which indicates the ability of publishers to reach the audience in the list 192. In the example of FIG. 5, the horizontal axis represents the number of total users reached by each publisher and the horizontal axis represents the percentage of users in the audience list reached by the different publishers. In this example, Publisher A has the highest percentage of users reached in list and relatively lower number of total users reached by it. Publisher B has the most users reached by it in total and a relatively high percentage of the users reached in the list. Comparatively, Publishers C reaches fewer users in the list 192 and Publisher D reaches fewer unique users in total.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
receiving an audience list, the audience list identifying a set of users associated with an interest topic;
receiving advertising impression data associated with one or more advertising impressions of advertisements provided by a plurality of advertising publishers;
identifying, for each advertising impression, a unique user that viewed or interacted with the advertisement based on the received advertising impression data;
determining whether each identified unique user associated with the received advertising impression data is in the audience list;
generating an audience report, the audience report indicating effectiveness of the plurality of advertising publishers in reaching the set of users in the audience list; and
sending the audience report for presentation to the plurality of advertising publishers.

2. The method of claim 1, wherein receiving the audience list comprises receiving the audience list from an audience list provider, the audience list including user identifiers that identify the set of users in the audience list.

3. The method of claim 1, wherein the audience list is also received by at least one of the plurality of advertising publishers for use in attempting to reach the users in the audience list with advertising impressions.

4. The method of claim 1, wherein the advertising impression data includes advertising information, the advertising information identifying an advertisement displayed on a page of an advertising publisher.

5. The method of claim 4, wherein the advertising information includes a campaign identifier and a publisher identifier, the campaign identifier identifying an advertising campaign associated with one advertisement impression for one advertisement, and the publisher identifier identifying an advertising publisher that displays the advertisement.

6. The method of claim 1, wherein receiving the advertising impression data comprises receiving the advertising impression data from one or more user devices that presented an advertisement to a user, and wherein identifying the user that viewed or interacted with the advertisement comprises receiving a token or cookie from the user device and identifying a user logged in to a social networking system based on the token or cookie.

7. The method of claim 6, wherein the social networking system storing user profile information of registered users of the social networking system, the user profile information identifying the registered users associated with one or more interest topics.

8. The method of claim 7, wherein the user profile information of the registered users of the social networking system includes demographic information such as name, age, gender or personal interests for specific products or services.

9. The method of claim 1, wherein user information of the identified unique user is corrected by panel data received from one or more panel data providers.

10. The method of claim 1, wherein determining whether each identified unique user associated with the received advertising impression data is in the audience list comprises matching each identified unique user with the set of users in the audience list.

11. The method of claim 1, wherein the generated audience report includes information of a set of identified unique users that are members in the audience list and information of a plurality of advertising publishers that provided the advertisements to the set of identified unique users.

12. The method of claim 11, wherein the generated audience report indicates a percentage of users of the set of users in the audience list that are reached by each advertising publisher.

13. A non-transitory computer-readable medium storing instructions for execution on a processor, the instructions when executed by the processor causing the processor to perform steps comprising:
receiving an audience list, the audience list identifying a set of users associated with an interest topic;
receiving advertising impression data associated with one or more advertising impressions of advertisements provided by a plurality of advertising publishers;
identifying, for each advertising impression, a unique user that viewed or interacted with the advertisement based on the received advertising impression data;
determining whether each identified unique user associated with the received advertising impression data is in the audience list;
generating an audience report, the audience report indicating effectiveness of the plurality of advertising publishers in reaching the set of users in the audience list; and
sending the audience report for presentation to the plurality of advertising publishers.

14. The non-transitory computer-readable medium of claim 13, wherein the audience list is also received by at least one of the plurality of advertising publishers for use in attempting to reach the users in the audience list with advertising impressions.

15. The non-transitory computer-readable medium of claim 13, wherein the advertising impression data includes advertising information, the advertising information identifying an advertisement displayed on a page of an advertising publisher.

16. The non-transitory computer-readable medium of claim 15, wherein the advertising information includes a campaign identifier and a publisher identifier, the campaign identifier identifying an advertising campaign associated with one advertisement impression for one advertisement, and the publisher identifier identifying an advertising publisher that displays the advertisement.

17. The non-transitory computer-readable medium of claim 13, wherein receiving the advertising impression data comprises receiving the advertising impression data from one or more user devices that presented an advertisement to a user, and wherein identifying the user that viewed or interacted with the advertisement comprises receiving a token or cookie from the user device and identifying a user logged in to a social networking system based on the token or cookie.

18. The non-transitory computer-readable medium of claim 13, wherein determining whether each identified unique user associated with the received advertising impression data is in the audience list comprises matching each identified unique user with the set of users in the audience list.

19. The non-transitory computer-readable medium of claim 13, wherein the generated audience report includes information of a set of identified unique users that are members in the audience list and information of a plurality of advertising publishers that provided the advertisements to the set of identified unique users.

20. The non-transitory computer-readable medium of claim 13, wherein the generated audience report indicates a percentage of users of the set of users in the audience list that are reached by each advertising publisher.
